(19) United States
(12) Patent Application Publication
(10) Pub. No.: US 2020/0209096 A1
(43) Pub. Date: Jul. 2, 2020

(54) FLUID LEAK AND MICROLEAK DETECTOR AND PROCEDURE FOR DETECTING LEAKS AND MICROLEAKS

(71) Applicant: TEG Technologies Research and Development, S.L., Vilablareix (Gerona) (ES)

(72) Inventors: Lluis Guixeras Nogue, Vilablareix (Gerona) (ES); Rafael Guixeras Llora, Vilablareix (Gerona) (ES)

(73) Assignee: TEG Technologies Research and Development, S.L., Vilablareix (Gerona) (ES)

(21) Appl. No.: 16/730,272

(22) Filed: Dec. 30, 2019

Related U.S. Application Data
(63) Continuation-in-part of application No. 15/527,585, filed on May 17, 2017, now abandoned.

(30) Foreign Application Priority Data
Nov. 18, 2014 (ES) P201431691

(51) Int. Cl. G01M 3/28; G08B 3/10

(52) U.S. Cl. CPC G01M 3/28; G08B 3/10

(57) ABSTRACT

A fluid leak and microleak detector that incorporates three aligned elements: the first element being a solenoid valve (4) that is aligned to the direction of flow, which is followed by a flowmeter (5) and finally a pressure switch (6). These items are managed and connected to an electronic board (7) which contains a computer application with two complementary routines; a routine that detects microleaks (13) for fluid losses greater than 0.15 l/h which is linked to the pressure switch (6) and the solenoid valve (4), and another routine that detects leaks (12) for fluid losses of around 3 l/h and greater, which is linked to the flowmeter (5) and the solenoid valve.

### CROSS-REFERENCE TO RELATED APPLICATIONS

This application is a continuation-in-part of U.S. patent application Ser. No. 15/527,585, filed May 17, 2017, entitled FLUID LEAK AND MICROLEAK DETECTOR AND PROCEDURE FOR DETECTING LEAKS AND MICROLEAKS, pending, which is a National Stage Entry of PCT/ES2015/070799 filed Nov. 9, 2015 claiming priority over Spain Patent application P201431691 filed Nov. 18, 2014, the disclosure of all the these applications are incorporated herein by reference.

### TECHNICAL FIELD

The present invention relates to a device for detecting fluid leaks; one of its main applications is to detect domestic leaks but it can be applied to any type of fluid distribution network.

This invention is capable of detecting fluid leaks and microleaks using a single device located at the inlet of the distribution network, detecting the leaks based on real time recorded values of flow and pressure.

### BACKGROUND OF THE INVENTION

Different devices are known for detecting liquid leaks, particularly devices that warn of leaks in homes, shops, offices and even industrial facilities. They respond to a leak in two ways: by emitting an optical/acoustic alarm, or by shutting off the general water supply.

These devices act according to three known techniques:

Moisture detection examples of this technology are the devices described in Utility Model U9501958, and U.S. Pat. Nos. 9,502,360 and 9,001,920. These have moisture sensors which on contact with water from a leak trigger an optical/acoustic alarm and in some cases cut off the water supply to the network. Their main problem is that they can only detect leaks in the specific areas of the network where the sensor is installed. If the leak occurs in a section that is not covered by the sensor system then it will not be detected. This requires multiple sensors to be installed throughout the distribution network, therefore resulting in a very expensive installation.

Detection by vibration—an example of this is the utility model U 161274. This is a less common technique that basically involves permanently monitoring a water distribution network to detect the characteristic sound of a water leak, whose position is located as a function of the soundwave intensity. This is an appropriate system for hidden conduits where the pipe burst is not in a visible area, but it is inappropriate for typical distribution networks used in homes, offices, shops and industrial facilities. There are high levels of vibration in these types of networks and it is possibly easier to implement a system based on moisture detection due to the numerous sections of exterior pipework.

Measurement of water flow at a point in the network. An example of this technology is described in patent ES 2 332 644 where two flow variables, their value (l/h) and their duration are studied to detect possible leaks. In this technology a flowmeter continually measures the flow of water through a control unit, where the reception time is also determined. This control unit incorporates a computer program that determines if there is a leak based on two axioms: Firstly, in a home, the flowmeter cannot record flow for more than a certain amount of time. If it does then the system assumes that there is a leak. Secondly, a value of maximum consumption for a home can be determined depending on the characteristics of the network (number of taps, number of bathrooms, washing machine, dishwasher . . . ) so a value greater than the maximum reference flowrate is assumed to be a water leak. In any case, the determination of a leak in the system is followed by an alarm among other possible measures including shutting off the supply by instructing a solenoid valve to close from the control unit.

This last leak detection technology can be considered as the most advanced, economical and easy to apply system for houses. However, it has two technical problems.

Firstly, it cannot detect leaks below 3 l/h because the flowmeters currently available are not able to detect lower flows.

Secondly, it is slow at determining a water leak. As the detection criterion is the

measurement of flow for longer than the reference time, the instruction to shut-off the main water supply is given when large volumes of water have already been released into the home.

Therefore, the proposed technical problem that the new invention solves is twofold: firstly, it detects water microleaks of less than 3 l/h and secondly, it is capable of determining leaks below the maximum flowrate value without waiting for a maximum 5 permissible period of continuous water flow to pass.

### SUMMARY OF THE INVENTION

The new leak and microleak detector whose patent is sought detects leaks of any type of fluid by measuring flow and pressure in the network.

Basically, the new system monitors the fluid flowrate in the network and is provided with an intelligent system that detects abnormal flowrates outside of the ranges of some predefined parameters. These flowrates are those considered as constituting a leak in the network.

Aside from detecting leaks, the new system is capable of detecting microleaks, which are fluid leaks of around 0.15 l/h, typically at joints, taps, valves, pores, or other events involving the loss of very small flows.

The novel detector is inserted into the inlet of the network. For example, in the case of a house, in the mains water inlet, preferably after the utility company's water meter.

Operationally the new detector consists of three elements that are all aligned. The first element is a solenoid valve that is aligned to the direction of flow, which is followed by a flowmeter and finally a pressure switch. These elements are managed and connected to an electronic board, a Programmable Logic Controller (PLC) or similar element, with which the user can interact via a keyboard, keypad, touch screen or any other suitable means to input data and select options.

All these elements can be incorporated into a body or housing that unites them into a single device.

One of the new features of this invention is that the electronic board houses a computer application with two complementary routine that act alternatively. One routine governs the pressure switch and the solenoid valve, and optionally also governs the flowmeter in more developed versions. The second routine governs the flowmeter and the solenoid valve.

The first routine aims to detect microleaks corresponding to fluid losses greater than 0.1 l/h, while the second routine detects leaks greater than 3 l/h.

The alternative operation of both routines ensures that any leak in the network above 0.15 l/h is detected, setting off a warning or alarm in the case of microleaks, and also shutting off the water supply for leaks greater than 3 l/h.

The location of microleaks is done with the first program routine as a one-off test at the user's request, or as part of a scheduled activity that runs at regular intervals.

Its operation follows the assumption that if there are no microleaks and the network is kept pressurized, then the fluid pressure should be kept constant. However, if there is a microleak then the fluid volume will decrease and therefore the pressure will also decrease.

This pressure differential can also be driven by changes in temperature or due to dilation of the network pipes or the fluid itself, so an algorithm is required to discern when there is a microleak and when not.

It is based on a network condition with no fluid consumption, so in the example of a home, all the taps are closed and any devices capable of consuming water are turned off.

In such conditions, the resident program on the electronic board sends a signal to the solenoid valve to put it in a closed position, thereby pressurizing the network. In the most basic versions, the user must ensure that all the taps are closed. However, in more developed versions the application will check that the recorded flowrate is 0 before closing the solenoid valve, so it is assumed that there is no consumption in the network. If this is not the case then the test is suspended.

After pressurizing the network, the pressure switch begins recording pressure measurements in the network (Pn) which are analyzed in the electronic board. This analysis consists of comparing the recorded value (Pn) with the previous value (Pn−1), verifying if:

(Pn)=(Pn−1)

or

(Pn)≠(Pn−1)

The number of matching results of each type is in turn recorded and analyzed by an algorithm programmed into the application, where the existence of a microleak is determined as a function of the time (Tt) and the number of matching results in set 10 periods of time (Tp).

During most of the day, the control of possible leaks is done using the second routine that only detects leaks above 3 l/h.

In this operating mode the electronic board analyses the recorded values from the flowmeter and compares them with reference values that have been introduced or selected with the device's keyboard or keypad, and it controls the time that passes since the start of the assessment.

Leak detection adheres to three principles:

1: The registered flowrate value at any time has a maximum allowable value (Qmax) depending on the characteristics of the network that is being monitored. A flowrate greater than (Qmax) is considered to be a leak.

2: The maximum time that a given flowrate can be registered (TQmax) is inversely proportional to its volume. In this way, a flowrate close to Qmax can only be registered for a short period of time, while a smaller flowrate may be recorded for longer. Each volume of flow (Qn) is associated with a maximum recording time (Tn). If the flow Qn is recorded for more than its associated time (Tn), it is considered to be a leak.

3: At some point the flowrate recorded must be zero because it is not possible for a network to have indefinite consumption, however small this may be. Therefore, a maximum registration period of uninterrupted flow (Tmax) is established. A flowrate that is recorded for longer than this time (Tmax), regardless of its value, is considered to be a leak.

Operationally, this routine has two phases. The reference values (Qmax), (Tmax) are set in the first phase by introducing them directly using the keypad, or by entering additional data such as the number of taps in the house, appliances susceptible to water consumption, watering points, etc. The values of (Qmax and Tmax), as well as the value of (TQmax), are deduced from this data based on the ratio Qn/Tn.

Following this, the actual leak detection is carried out in the second phase. In this phase, the application records the total time that passes since the start of the evaluation (Tt), as well as the flowrate values (Qn), and it carries out an analysis of the information received. (Tt) becomes 0 when the registered flow (Qn) is zero.

The variables used in this analysis are:

Qn: nth flowrate value

Qn−1: Value before Qn

Tt: Current time value

Tn: Maximum time associated with the value Qn

Tn−1: Maximum time associated with Q−1

Tmax: maximum recordable time

Qmax: maximum recordable flowrate

The leak alarm subroutine involves two basic actions. The first is to send a signal to the solenoid valve to move it to its closed position and shut-off the mains water supply and therefore stop the leak. The second is to send a signal alerting the user which may be a warning light and/or sound for example. Apart from the two basic actions, the alarm subroutine may include other complementary commands, such as sending out a call for assistance to a failure centre, an SMS, email, etc.

The new detector has several advantages: it is able to diagnose a leak in less time than other systems because its algorithm is able to establish whether there is a leak before reaching Tmax and issue an alarm.

It is a scalable and reprogrammable system so that the device can be used in all types of houses by simply inputting the required baseline data about the number of taps, bathrooms, washing machines, etc.

It is able to carry out a test of the water distribution network to detect microleaks on demand or as part of a scheduled task. Therefore, the house's residents will be told when there is a breakage in the network where water is being lost in large volumes. This could be a defect or misalignment that loses fluid in very small amounts and is completely undetectable by the current detection devices.

### BRIEF DESCRIPTION OF THE DRAWINGS

Drawings are attached with the aim of illustrating what has been explained in this report, in which:

FIG. 1 shows a schematic view of the leak detection device according to the present invention installed in a domestic water distribution network;

FIG. 2 shows a diagram showing the connectivity and relationships between the various system components;

FIG. 3 shows a diagram of the leak detection routine;

FIG. 4 shows a diagram of the microleak detection routine; and

FIG. 5 shows a graph of flow/time, where the leak detection limits are set according to the reference values.

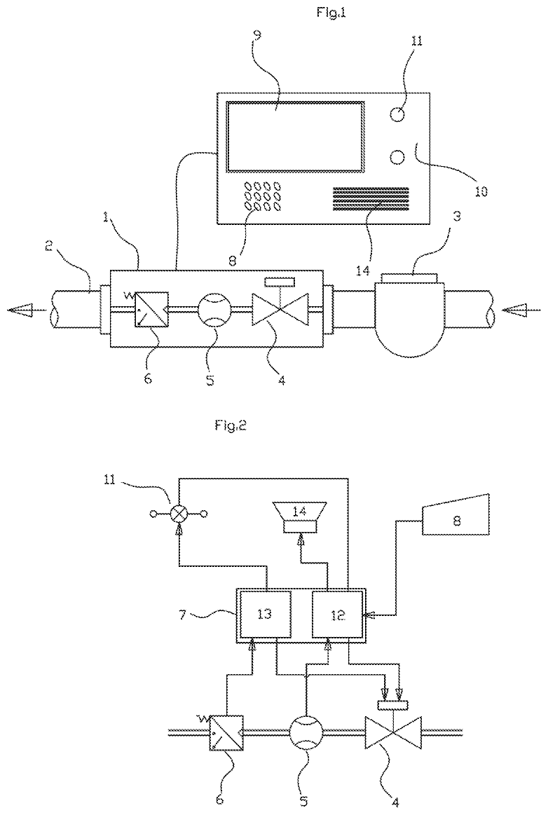

### REFERENCE LIST

1. Body
2. House pipework
3. Water meter
4. Solenoid valve
5. Flowmeter
6. Pressure switch
7. Electronic board
8. Keypad
9. Alphanumeric display
10. Control panel
11. Pilot lights
12. Leak routine
13. Microleak routine
14. Sound generator

### DESCRIPTION OF THE INVENTION

This example corresponds to a leak detector device based on this invention prepared to be used as a domestic water leak detector.

According to the invention, the new water detector described has a body (1) that is inserted into the household water inlet (2) after the utility company's water meter (3).

The body (1) incorporates a solenoid valve (4), a flowmeter (5) and a pressure switch (6), all operatively interconnected with the control panel (10) which consists of an electronic board (7) in its interior, and a sound generator (14), a keypad (8), an alphanumeric display (9) and a set of pilot lights (11) on its exterior.

The electronic board (7) houses a computer application with two independent routines, which act alternately: one dedicated to detecting microleaks (13) which determines fluid losses greater than 0.15 l/h, and another dedicated to detecting leaks (12) which detects irregular fluid losses greater than 3 l/h.

According to the connectivity diagram shown in FIG. 2, the pressure switch (6), the solenoid valve (4), the keypad (8), the alphanumeric display (9) and a pilot light (11) are linked to the microleak detection routine (13). The flowmeter (5), the solenoid valve (4), the keypad (8), the alphanumeric display (9) a pilot light (11) and the sound generator (14) are linked to the leak detection routine (12).

The application housed in the electronic board (7) records the flow values (Qn) measured by the flow meter and the pressure values (Pn) measured by the pressure switch. According to programmed algorithms, it sends operating signals to the solenoid valve (4), to the pilot lights (11), the sound generator (14) and the alphanumeric display (9). The algorithms can be edited via the keypad (8).

Specifically, the variables of Qmax, Tmax and TQmax used in the leak routine (12) are input with via the keypad (8) and correspond to:

Qmax: Maximum flow that the household can consume depending on the number of taps, toilets, bidets, sinks, washing machines and dishwashers they have.

Tmax: Maximum time during which water consumption can be detected without taking any action, however small it may be.

TQmax: Maximum time that a flow value can be registered, with the value of time being inversely proportional to the value of the recorded flow.

These variables give rise to a composite function which is represented in the graph in FIG. 5. According to this function, any value that falls out of the dark area is a water leak.

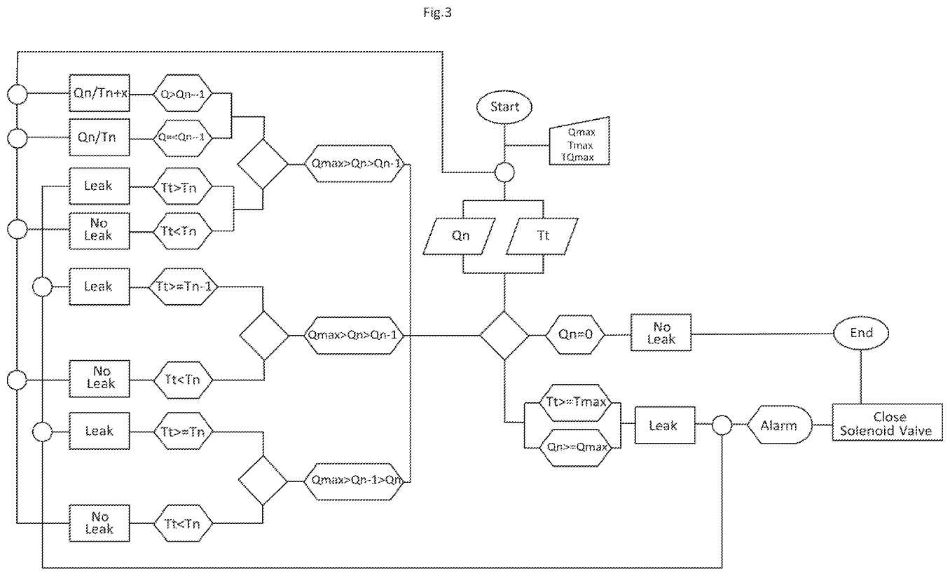

According to FIG. 3, the description of the leak routine (12) is:

When the application starts, a process that closes the solenoid valve (4) begins, thereby pressurizing the system.

The user may load into the electronic board (7) pre-set value for the maximum recordable flowrate (Qmax), pre-set value for the maximum time that a flow value can be registered (TQmax), and pre-set value for the maximum time during which network consumption can be detected continuously (Tmax). All of the pre-set values are standard values that are already been established depending on several factors, for example, the type of building or house, number of faucets, and number of toilets.

Then, the electronic board (7) records the present flow values (Qn) measured by the flow meter, the pressure values (Pn) measured by the pressure switch, and starts recording time elapsed since the start of the leak routine (12).

This is phase 1 of the routine and should not be repeated again unless the characteristics of the network are changed.

The program on the leak routine (12) compares present flow values (Qn) and the present pressure values (Pn) with the pre-set value for the maximum recordable flowrate (Qmax), the pre-set value for the maximum time that a flow value can be registered (TQmax), and pre-set value for the maximum time during which network consumption can be detected continuously (Tmax).

The comparation have six possible outcomes.

Qn=0

Qn>=Qmax

Tt>=Tmax

Qmax>Qn>Qn−1

Qmax>Qn=Qn−1

Qmax>Qn−1>Qn

If Qn=0, then there is no network consumption, and therefore no possibility of having a leak. This result ends the application's routine (12), which is then restarted from the beginning.

If Qn>=Qmax and Tt>=Tmax, then there is a leak and an alarm will be triggered and the program will send a signal to close the solenoid valve.

If Qmax>Qn>Qn−1 and Tt>=Tn−1, then there is a leak and an alarm will be triggered.

If Qmax>Qn=Qn−1 and Tt<Tn, then there is not a leak.

If Qmax>Qn−1>Qn and Tt>=Tn, then there is a leak and an alarm will be triggered.

If Qmax>Qn−1>Qn and Tt<Tn, then there is not a leak.

If Qmax>Qn>Qn−1 and Tt<Tn, then there is not a leak.

If Qmax>Qn>Qn−1 and Tt>Tn, then there is a leak and an alarm will be triggered.

If Qmax>Qn>Qn−1 and Q=<Qn−1 and Qn/Tn, an alarm will be triggered and the program will send a signal to close the solenoid valve.

If Qmax>Qn>Qn−1 and Q=<Qn−1 and Qn/Tn+x, an alarm will be triggered and the program will send a signal to close the solenoid valve.

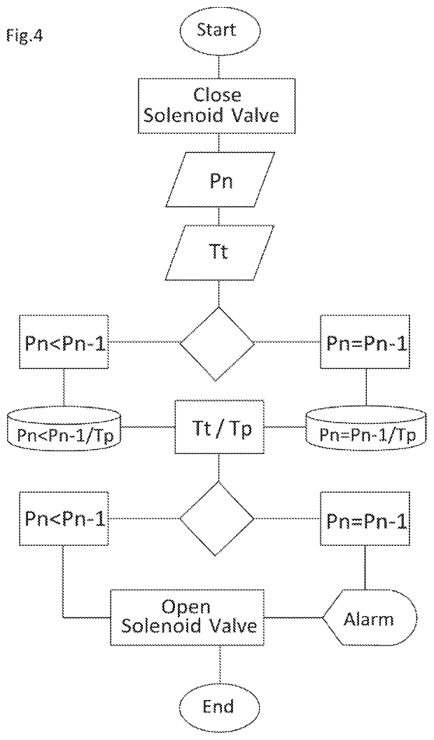

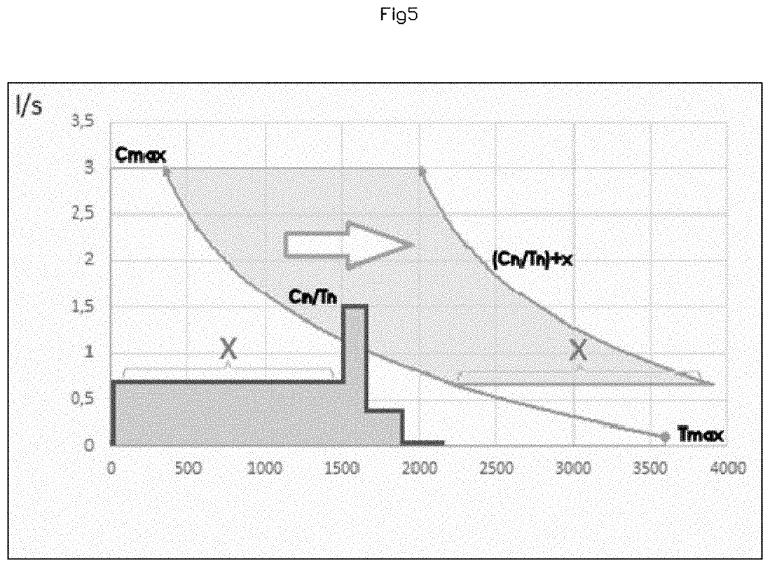

According to FIG. 4, the description of the microleak routine (13) is:

When the application starts, a process that closes the solenoid valve (4) begins, thereby pressurizing the system.

The microleak routine (13) includes the following variables:

Pn: Pressure value registered in the network in real time;

Pn−1: Pressure value of the network before Pn;

Tt: Total elapsed time since the start of the routine; and

Tp: Time interval for the recount of the results.

The system measures the pressure record (Pn) and time record (Tt) and the results send to the electronic board with two possible outcomes:

Pn=Pn−1

Pn≠Pn−1

The program recounts the number of the identical results obtained during the time interval (Tp) and memory storage. The interval time may be, for example, 10 minutes.

Then, the program relates the number of repeated results recorded during the time interval (Tp) with the total elapsed time (Tt).

If Pn=Pn−1 are the same through the time interval (Tp), then, there is not a leak and the system will open the solenoid valve.

If Pn<Pn−1 thought the results during the time interval (Tp), then, there is a leak and the system will close the solenoid valve and trigger an alarm.

The alarm may be a switch, audible, visual alarm, etc.

1. A fluid leak and microleak detector comprising:
a housing adapted to be inserted into a household water inlet after a water meter, the housing including:
a flow meter,
a pressure switch, and
a solenoid valve, wherein the solenoid valve is placed in the direction of flow (4) followed by the flow meter (5), and then the pressure switch (6);
a control panel including:
an electronic circuit board (7) operatively connected to the flow meter (5), the pressure switch (6) and the solenoid valve (4);
a sound generator;
a keypad;
an alphanumeric display; and
at least one pilot light;
wherein the electronic board (7) contains a computer application including:
a first leak routine that detects microleaks (13) for fluid losses above 0.15 l/h, the first leak routine is linked to the pressure switch (6) and the solenoid valve (4), the keypad, the alphanumeric display; and the at least one pilot light; and
a second leak routine that detects leaks (12) for fluid losses of around 3 l/h and greater, the second leak routine is linked to the flowmeter (5), the solenoid valve (4), the keypad, the alphanumeric display; the at least one pilot light, and the sound generator;
wherein the first leak routine that detects microleaks (13) includes the following variables:
Pn: Pressure value registered in the network in real time;
Pn−1: Pressure value of the network before Pn;
Tt: Total elapsed time since the start of the routine; and
Tp: Time interval for the recount of the results;
wherein if Pn=Pn−1 through the time interval (Tp), then, there is not a leak and the system open the solenoid valve;
wherein if Pn<Pn−1 through the time interval (Tp), then, there is a leak and the system close the solenoid valve and trigger an alarm;
wherein the second leak routine that detects leaks (12) includes:
a pre-set value for a maximum recordable flowrate (Qmax);
a pre-set value for a maximum time that a flow value is registered (TQmax); and
a pre-set value for a maximum time during which a network consumption is detected continuously (Tmax);
wherein the electronic board (7) records present flow values (Qn) measured by the flow meter, the pressure values (Pn) measured by the pressure switch, and starts recording time elapsed since the start of the second leak routine (12);
wherein a program on the second leak routine (12) compares present flow values (Qn) and the present pressure values (Pn) with the pre-set value for the maximum recordable flowrate (Qmax), the pre-set value for the maximum time that a flow value can be registered (TQmax), and pre-set value for the maximum time during which network consumption can be detected continuously (Tmax);
if Qn=0, then there is no a leak;
if Qn>=Qmax and Tt>=Tmax, then there is a leak and the program sends a signal to trigger an alarm and to close the solenoid valve;
if Qmax>Qn>Qn−1 and Tt>=Tn−1, then there is leak and an alarm is triggered.
if Qmax>Qn=Qn−1 and Tt<Tn, then there is not leak;
if Qmax>Qn−1>Qn and Tt>=Tn, then there is leak and an alarm is triggered.
if Qmax>Qn−1>Qn and Tt<Tn, then there is not leak;
If Qmax>Qn>Qn−1 and Tt<Tn, then there is not leak;
if Qmax>Qn>Qn−1 and Tt>Tn, then there is leak and an alarm is triggered;
if Qmax>Qn>Qn−1 and Q=<Qn−1 and Qn/Tn, then there is leak an alarm is triggered and the program sends a signal to close the solenoid valve.
if Qmax>Qn>Qn−1 and Q=<Qn−1 and Qn/Tn+x, then there is leak an alarm is triggered and the program sends a signal to close the solenoid valve; and
wherein the first leak routine is independent from the second leak routine and act alternately from each other.

2. A method for detecting fluid leaks and microleaks, the method including the steps of:
a) providing a fluid leak and microleak detector system comprising:
a housing adapted to be inserted into a household water inlet after a water meter, the housing including:
a flow meter,
a pressure switch, and
a solenoid valve, wherein the solenoid valve is placed in the direction of flow (4) followed by the flow meter (5), and the pressure switch (6);
a control panel having:
a control panel including:
an electronic circuit board (7) or a programmable logic controller (PLC), the electronic board (7) or the programmable logic controller (PLC) is operatively connected to the flow meter (5), the pressure switch (6) and the solenoid valve (4),
a sound generator to produce an alarm;
a keypad;
an alphanumeric display; and
at least one pilot light;
wherein the electronic board (7) or the programmable logic controller (PLC) contains a computer application including:
a first leak routine that detects microleaks (13) for fluid losses above 0.15 l/h, the first leak routine is linked to the pressure switch (6) and the solenoid valve (4), the keypad, the alphanumeric display; and the at least one pilot light; and
a second leak routine that detects leaks (12) for fluid losses of around 3 l/h and greater, the second leak routine is linked to the flowmeter (5), the solenoid valve (4), the keypad, the alphanumeric display; the at least one pilot light, and the sound generator; wherein the first leak routine is independent from the second leak routine and act alternately from each other;
b) closing the solenoid valve to pressurized the system;
c) recording flow readings from the flowmeter (5) and pressure readings from the pressure switch (6) and sending the results to the on the electronic board;
d) sending operating signals by using the programable algorithm to the solenoid valve, the at least one pilot light, the sound generator, and the alphanumeric display;
wherein the first leak routine that detects microleaks (13) includes the following variables:
Pn: Pressure value registered in the network in real time;
Pn−1: Pressure value of the network before Pn;
Tt: Total elapsed time since the start of the routine; and
Tp: Time interval for the recount of the results;
wherein if Pn=Pn−1 through the time interval (Tp), then, there is not a leak and the system open the solenoid valve;
wherein if Pn<Pn−1 through the time interval (Tp), then, there is a leak and the system close the solenoid valve and trigger an alarm;
wherein the second leak routine that detects leaks (12) includes:
a pre-set value for a maximum recordable flowrate (Qmax);
a pre-set value for a maximum time that a flow value is registered (TQmax); and
a pre-set value for a maximum time during which a network consumption is detected continuously (Tmax);
wherein the electronic board (7) records present flow values (Qn) measured by the flow meter, the pressure values (Pn) measured by the pressure switch, and starts recording time elapsed since the start of the second leak routine (12);
wherein a program on the second leak routine (12) compares present flow values (Qn) and the present pressure values (Pn) with the pre-set value for the maximum recordable flowrate (Qmax), the pre-set value for the maximum time that a flow value can be registered (TQmax), and pre-set value for the maximum time during which network consumption can be detected continuously (Tmax);
if Qn=0, then there is no a leak;
if Qn>=Qmax and Tt>=Tmax, then there is a leak and the program sends a signal to trigger an alarm and to close the solenoid valve;
if Qmax>Qn>Qn−1 and Tt>=Tn−1, then there is leak and an alarm is triggered.
if Qmax>Qn=Qn−1 and Tt<Tn, then there is not leak;
if Qmax>Qn−1>Qn and Tt>=Tn, then there is leak and an alarm is triggered.
if Qmax>Qn−1>Qn and Tt<Tn, then there is not leak;
If Qmax>Qn>Qn−1 and Tt<Tn, then there is not leak;
if Qmax>Qn>Qn−1 and Tt>Tn, then there is leak and an alarm is triggered;
if Qmax>Qn>Qn−1 and Q=<Qn−1 and Qn/Tn, then there is leak an alarm is triggered and the program sends a signal to close the solenoid valve.
if Qmax>Qn>Qn−1 and Q=<Qn−1 and Qn/Tn+x, then there is leak an alarm is triggered and the program sends a signal to close the solenoid valve; and
wherein the first leak routine is independent from the second leak routine and act alternately from each other.
